(19) United States
(12) Patent Application Publication
(10) Pub. No.: US 2026/0034522 A1
(43) Pub. Date: Feb. 5, 2026

(54) AIR SUCTION PROTECTION STRUCTURE FOR MICROBUBBLE DEVICE

(71) Applicant: JODEN INC., Guangdong (CN)

(72) Inventor: Zhengfeng XU, Jiangmen, Guangdong (CN)

(21) Appl. No.: 18/703,867

(22) PCT Filed: Nov. 7, 2023
(86) PCT No.: PCT/CN2023/130231

§ 371 Date: Mar. 26, 2025

(30) Foreign Application Priority Data
Dec. 9, 2022 (CN) 2022115864010

(51) Int. Cl. B01F 25/312; B01F 23/2326; B01F 23/237; B01F 23/2373; B01F 25/10; B01F 25/452

(52) U.S. Cl. CPC B01F 25/31251; B01F 23/2326; B01F 23/2373; B01F 23/237611; B01F 25/103; B01F 25/3121; B01F 25/4521

(57) ABSTRACT

An air suction protection structure for a microbubble device includes a first throat pipe, a second throat pipe and an air suction pipe. The first throat pipe is provided with a conical opening from which a liquid flow enters the first throat pipe. The liquid flow increases its flow speed after passing through the conical opening. The second throat pipe is communicated with the first throat pipe and located downstream of the first throat pipe, a protection area is arranged on an inner wall of the second throat pipe, and the liquid flow does not contact with an inner wall surface of the second throat pipe within a range of the protection area when passing through the protection area. Meanwhile, the air suction pipe is communicated with the second throat pipe, the air suction pipe is provided with an air suction port connected to the protection area.

### CROSS-REFERENCE TO RELATED APPLICATIONS

This application is a national stage filing under 35 U.S.C. § 371 of international application number PCT/CN2023/130231, filed Nov. 7, 2023, which claims priority to Chinese patent application No. 2022115864010, filed Dec. 9, 2022. The contents of these applications are incorporated herein by reference in their entirety.

### TECHNICAL FIELD

The present disclosure relates to the technical field of microbubble devices, and particularly to an air suction protection structure for a microbubble device.

### BACKGROUND OF THE INVENTION

In the fields such as aquaculture, wastewater treatment, chemical reaction, medical hygiene, plant cultivation, industrial cleaning and descaling, it is often necessary to mix air into water to obtain an aqueous working medium containing bubbles. At present, devices such as compressors and air pumps are used to produce bubbles. Alternatively, air may also be sucked in with a negative pressure generated by a water flow, such as Venturi pipe structures, or vortex structures. However, in structural designs of the existing Venturi pipe, due to the viscosity of the liquid, together with the fact that the air suction hole is typically arranged in a side wall of the pipe, a part of the liquid may adhere to the air suction hole or even seep out from the air suction hole when the liquid flows through the air suction hole, which will seriously affect the air suction stability, resulting in unstable work or the failure of bubble generation.

### SUMMARY OF THE INVENTION

The present disclosure aims to solve at least one of the technical problems in the existing technology, and to provide an air suction protection structure for a microbubble device, which can prevent liquid from adhering to an air suction hole, thus improving working stability.

An embodiment of the present disclosure provides an air suction protection structure for a microbubble device, which comprises:
a first throat pipe provided with a conical opening, wherein the conical opening is arranged to allow a liquid flow to enter the first throat pipe from the conical opening, and to increase a flow speed of the liquid flow after the liquid flow passes through the conical opening;
a second throat pipe communicated with the first throat pipe and located downstream of the first throat pipe, wherein a protection area is arranged on an inner wall of the second throat pipe, and the protection area is arranged to prevent the liquid flow from contacting with an inner wall surface of the second throat pipe within the protection area; and
an air suction pipe communicated with the second throat pipe, wherein the air suction pipe is provided with an air suction port connected to the protection area.

The air suction protection structure for a microbubble device according to the present disclosure has at least the following beneficial effects. In this embodiment, the first throat pipe, the second throat pipe and the air suction pipe are provided, the first throat pipe is provided with the conical opening, the liquid flow enters the first throat pipe from the conical opening, the flow speed of the liquid flow is increased after the liquid flow passes through the conical opening, and the liquid flow with the increased flow speed facilitates to produce a low pressure in the air suction pipe so as to realize an air suction function. The second throat pipe is communicated with the first throat pipe and located downstream of the first throat pipe, the protection area is arranged on the inner wall of the second throat pipe, and the liquid flow does not contact with the inner wall surface of the second throat pipe within the protection area when passing through the protection area. Meanwhile, the air suction pipe is communicated with the second throat pipe, the air suction pipe is provided with the air suction port, the air suction port is connected to the protection area, and the protection area is used for preventing the passing liquid flow from adhering to the air suction port, or even leaking into the air suction port, which would otherwise cause the instability or even failure of bubble generation, thus being conductive to improving the stability of bubble generation.

In the air suction protection structure for a microbubble device of the present disclosure, wherein the protection area is surrounded by an extension line of an inner wall of the first throat pipe, the inner wall surface of the second throat pipe and an extension line of the conical opening.

In the air suction protection structure for a microbubble device of the present disclosure, wherein an inner diameter of the second throat pipe is greater than an inner diameter of the first throat pipe, and a cross-sectional area of the second throat pipe is not greater than twice of a cross-sectional area of the first throat pipe.

In the air suction protection structure for a microbubble device of the present disclosure, wherein an extension line of an inner wall of the conical opening intersects with the inner wall surface of the second throat pipe.

In the air suction protection structure for a microbubble device of the present disclosure, wherein an expansion port is arranged downstream of the second throat pipe, and a diameter of the expansion port is continuously increased in a downstream direction.

In the air suction protection structure for a microbubble device of the present disclosure, a structural member is further comprised, wherein the structural member comprises the first throat pipe, the second throat pipe and the air suction pipe.

In the air suction protection structure for a microbubble device of the present disclosure, wherein a bubble refining device is arranged downstream of the expansion port, and the bubble refining device comprises a microhole plate.

In the air suction protection structure for a microbubble device of the present disclosure, wherein the bubble refining device comprises a vortex member, and the vortex member is configured to generate a vortex to refine bubbles when the liquid flow with the bubbles passes through the vortex member.

In the air suction protection structure for a microbubble device of the present disclosure, wherein the bubble refining device is provided with a flow rectifying plate for increasing flow resistance and controlling the flow speed of the liquid flow.

In the air suction protection structure for a microbubble device of the present disclosure, wherein the bubble refining device comprises a pressure maintaining member in which a pressure stabilizing cavity for preventing bubbles in water from overflowing is arranged.

Additional aspects and advantages of the present disclosure will be given in part in the following description, which will become apparent from the following description or be understood through practice of the present disclosure.

### BRIEF DESCRIPTION OF THE DRAWINGS

The present disclosure is further described hereinafter with reference to the drawings and embodiments.

FIG. 1 is a cross-sectional view of an air suction protection structure for a microbubble device according to an embodiment of the present disclosure;

FIG. 2 is a schematic view of air flow and liquid flow directions of the air suction protection structure for a microbubble device according to an embodiment of the present disclosure;

FIG. 3 is a cross-sectional view of a bubble refining device according to an embodiment in a first aspect of the present disclosure;

FIG. 4 is a cross-sectional view of a bubble refining device according to an embodiment in a second aspect of the present disclosure; and

FIG. 5 is a cross-sectional view of a bubble refining device according to an embodiment in a third aspect of the present disclosure.

### REFERENCE NUMERALS

100 refers to first throat pipe; 101 refers to conical opening; 102 refers to conical hole extension line; 103 refers to first extension line; 104 refers to air flow direction; 105 refers to liquid flow direction; 106 refers to structural member; 107 refers to shell; 108 refers to sealing ring; 109 refers to air inlet; 110 refers to second throat pipe; 111 refers to protection area; 112 refers to air suction pipe; 113 refers to air suction port; 114 refers to expansion port; 116 refers to microhole plate; 117 refers to vortex member; 118 refers to vortex space; 119 refers to flow rectifying plate; 120 refers to pressure maintaining member; 121 refers to pressure stabilizing cavity; and 122 refers to guide cone.

### DETAILED DESCRIPTION OF THE INVENTION

Specific embodiments of the present disclosure will be described in detail in this part, preferred embodiments of the present disclosure are shown in the drawings, and the drawings are intended to replenish the description in the written part of the specification with figures, so that people can intuitively and vividly understand each technical feature and the overall technical solution of the present disclosure, but it cannot be understood as a limitation to the scope of protection of the present disclosure.

In the description of the present disclosure, it should be understood that, the orientation or position relationship related to the orientation description, such as the orientation or position relationship indicated by the terms “upper”, “lower”, “front”, “rear”, “left”, “right”, and the like is based on the orientation or position relationship shown in the drawings, which is only used for facilitating and simplifying the description of the present disclosure instead of indicating or implying that the indicated device or element must have a specific orientation, and be constructed and operated in a specific orientation, and thus should not be understood as a limitation to the present disclosure.

In the description of the present disclosure, the meaning of several refers to being one or more, and the meaning of multiple refers to being two or more. The meanings of greater than, less than, more than, etc., are understood as not comprising the following number, while the meanings of above, below, within, etc., are understood as comprising the following number. If the terms such as first and second, if described, are only for the purpose of distinguishing technical features, and should not be understood as indicating or implying relative importance, implicitly indicating the number of the indicated technical features or implicitly indicating the order of the indicated technical features.

In the description of the present disclosure, unless otherwise explicitly defined, the terms such as “setting”, “mounting” and “connecting” should be understood in a broad sense, and those of ordinary skills in the art can reasonably determine the specific meanings of the above terms in the present disclosure in combination with the specific contents of the technical solution.

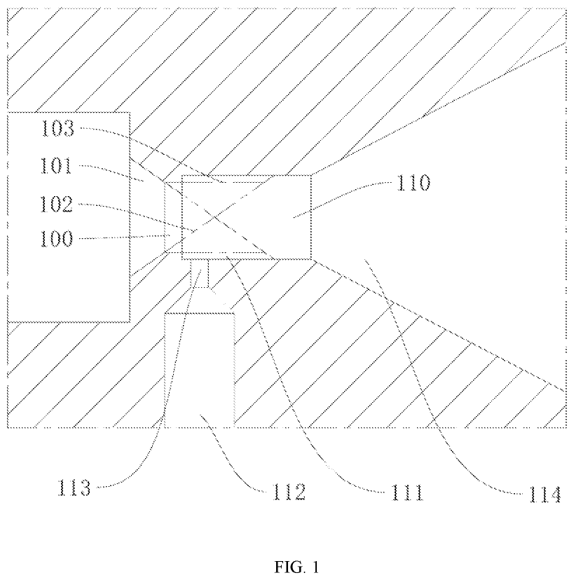

With reference to FIG. 1 to FIG. 5, an embodiment of the present disclosure provides an air suction protection structure for a microbubble device, which comprises a first throat pipe 100, a second throat pipe 110 and an air suction pipe 112. The first throat pipe 100 is located upstream of the second throat pipe 110. A conical opening 101 is arranged upstream the first throat pipe 100. Liquid flow enters the first throat pipe 100 from the conical opening 101. According to the principle of a Venturi pipe, the conical opening 101 causes a reduction in the diameter of the opening through which the liquid flows, resulting in an increase in flow speed after passing through the conical opening 101. The increased flow speed facilitates the creation of low pressure in the air suction pipe 112, thereby realizing the air suction function. The second throat pipe 110 is communicated with the first throat pipe 100. A protection area 111 is arranged on an inner wall of the second throat pipe 110, and the liquid flow does not contact with an inner wall surface of the second throat pipe 110 within the protection area 111 when passing through the protection area 111. Meanwhile, the air suction pipe 112 is communicated with the second throat pipe 110, the other end of the air suction pipe 112 is communicated with the atmosphere. The air suction pipe 112 is provided with an air suction port 113 communicated with the second throat pipe 110 and connected to the protection area 111. The protection area 111 is used for preventing the passing liquid flow from adhering to the air suction port 113, or even leaking into the air suction port 113, which would otherwise cause the instability or even failure of bubble generation. Therefore, the above design facilitates improving the stability of bubble generation. Optionally, the air suction pipe 112 may have a cross-section of any shape such as circular, rectangular, or polygonal according to the requirements of the molding process. Moreover, the air suction pipe 112 and the air suction port 113 may be integrated without segmentation, so that the air suction pipe 112 is directly communicated with the second throat pipe 110, which can still realize the air suction function.

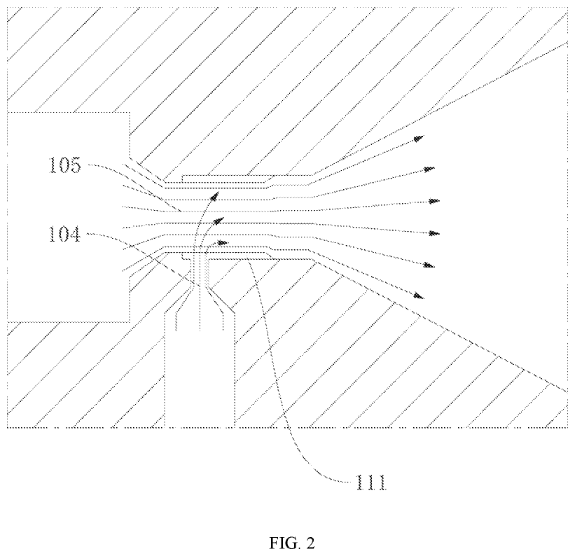

Further, the protection area 111 is surrounded by an extension line of an inner wall of the first throat pipe 100, the inner wall surface of the second throat pipe 110 and an extension line of the conical opening 101. With reference to FIG. 1, the extension line of the inner wall of the first throat pipe 100 is a first extension line 103, the extension line of the conical opening 101 is a conical hole extension line 102, and the protection area 111 is surrounded by the conical hole extension line 102, the first extension line 103 and the inner wall surface of the second throat pipe 110. Optionally, an inner diameter of the second throat pipe 110 is greater than an inner diameter of the first throat pipe 100, so that when the liquid flow passes through the second throat pipe 110, the inner diameter of the second throat pipe 110 is increased, and the liquid flow does not pass through the protection area 111, which can realize the protection of the air suction port 113, thus preventing the liquid from contacting with and adhering to the air suction port 113, and ensuring the stability of the bubble generation. Optionally, a cross-sectional area of the second throat pipe 110 is not greater than twice of a cross-sectional area of the first throat pipe 100. The inner diameter of the second throat pipe 110 is limited to prevent the liquid flow from excessively diffusing in the second throat pipe 110, thus preventing the problems of excessive liquid gaps and large permeating air bubbles, and also preventing the reduction of air suction efficiency caused by excessively high protection area 111. Optionally, the extension line of the inner wall of the conical opening 101 intersects with the inner wall surface of the second throat pipe 110, that is, the protection area 111 always falls within the second throat pipe 110. Limiting the protection area 111 is conductive to ensuring good air suction efficiency. Further, the air suction port 113 is located at the protection area 111 close to an end portion of the first throat pipe 100. Because the liquid flow is in a trumpet-shaped diffusion state in the second throat pipe 110 when the liquid flow is ejected from the first throat pipe 100, the proximity of the air suction port 113 to the first throat pipe 100 is conductive to preventing the liquid flow from contacting with the air suction port 113 as much as possible. Optionally, an axial direction of the air suction port 113 intersects with an axial direction of the second throat pipe 110, which is conductive to ensuring full contact between sucked air and the liquid flow, thus realizing stable bubble generation. With reference to FIG. 2, an air flow direction 104 and a liquid flow direction 105 are marked, an expansion port 114 is arranged downstream of the second throat pipe 110, and a diameter of the expansion port 114 is continuously increased in a downstream direction. The conical opening 101, the first throat pipe 100, the second throat pipe 110 and the expansion port 114 form a Venturi pipe, where the liquid flow decreases its speed and exhibits radial spraying after reaching the expansion port 114.

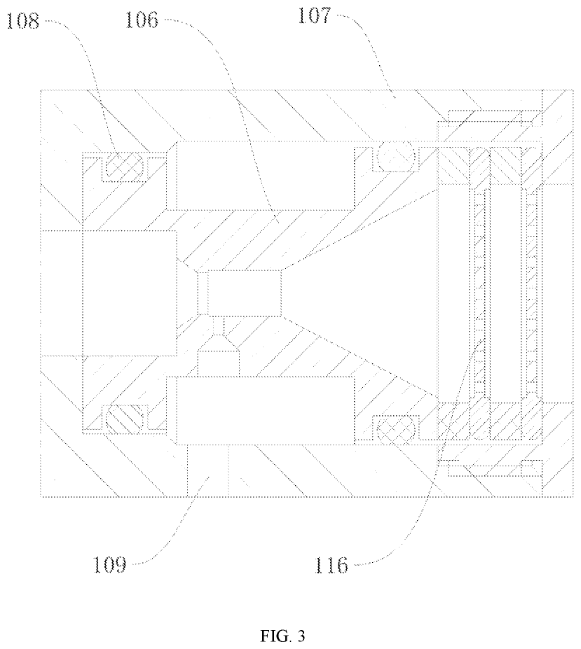

Optionally, a bubble refining device is arranged downstream of the expansion port 114. With reference to FIG. 3, in an embodiment in a first aspect, a structural member 106 is provided within which the conical opening 101, the first throat pipe 100, the second throat pipe 110 and the expansion port 114 are arranged. The structural member 106 is an independently mounted part, which is convenient to mount different bubble refining devices on the structural member 106. Optionally, the bubble refining device is provided with a shell 107, the structural member 106 is arranged in the shell 107, and a sealing ring 108 is arranged between the structural member 106 and the shell 107, so as to realize air and liquid sealing. Optionally, the shell 107 is provided with an air inlet 109 communicated with the air suction pipe 112. Optionally, the bubble refining device comprises at least one microhole plate 116. Optionally, the microhole plate 116 is perpendicular to an axial direction of the second throat pipe 110 and provided with a plurality of tiny through holes. After the liquid flow with bubbles passes through the tiny through holes, the bubbles are squeezed to have a smaller volume, so as to achieve the purpose of refining the bubbles. Moreover, the microhole plate 116 can generate certain resistance to the liquid flow, which is conductive to maintaining a pressure of the liquid flow and preventing a rapid loss of the bubbles.

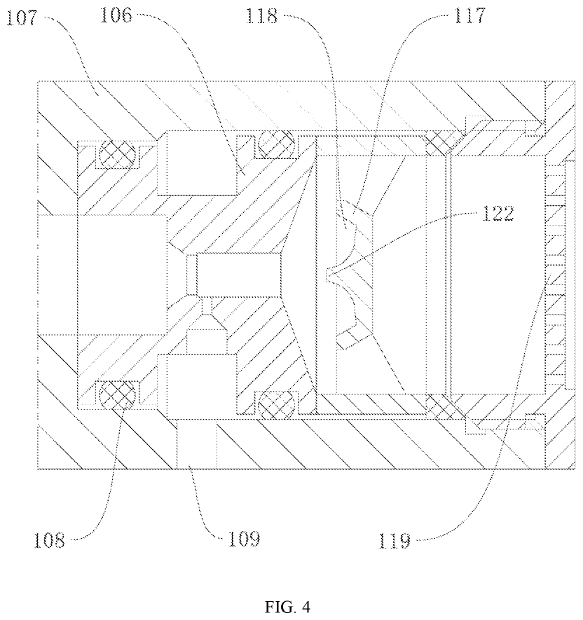

With reference to FIG. 4, in an embodiment in a second aspect, the bubble refining device comprises a vortex member 117 downstream of the expansion port 114. A vortex is generated to refine bubbles when the liquid flow with the bubbles passes through the vortex member 117. Specifically, a guide cone 122 is arranged in a middle portion of the vortex member 117, a tip end of the guide cone 122 is oriented upstream, an arc-shaped recess is arranged at either side of the guide cone 122, which forms a vortex space 118. When the liquid flow passes through the vortex member 117, the liquid flow follows a wall surface of the arc-shaped recess under the guidance of the guide cone 122, and the liquid flow with the bubbles generates the vortex in the vortex space 118, thus realizing the bubble refining effect. Optionally, a flow rectifying plate 119 is arranged downstream of the vortex member 117. The flow rectifying plate 119 is provided with a plurality of through holes, and the number of the through holes of the flow rectifying plate 119 is smaller than the number of the microhole plate 116. The flow rectifying plate 119 is used for increasing resistance to the liquid flow, which can maintain the liquid flow roll continuously and effectively. Moreover, the flow rectifying plate 119 may control a direction of the liquid flow, so as to prevent the liquid flow from being affected by an upstream vortex, thus ensuring a good liquid outlet pressure. In an embodiment in another aspect, the vortex member 117 and the microhole plate 116 may be used in combination, which can also realize the functions of refining the bubbles and maintaining the pressure of the liquid flow.

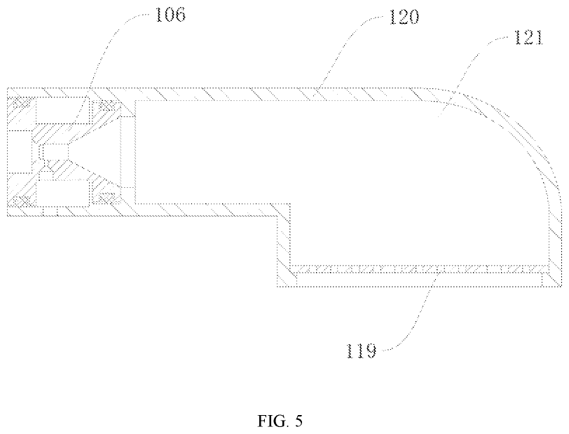

With reference to FIG. 5, in an embodiment in a third aspect, the bubble refining device comprises a pressure maintaining member 120 in which a pressure stabilizing cavity 121 for preventing bubbles in water from overflowing is arranged. Optionally, the pressure maintaining member 120 has a certain length, and the flow rectifying plate 119 is arranged downstream of the pressure maintaining member 120. Optionally, the flow rectifying plate 119 on the pressure maintaining member 120 is arranged to be perpendicular to the direction of the liquid flow. In this way, the liquid flow in the pressure maintaining member 120 rotates by a certain angle in the pressure stabilizing cavity 121, and the flow rectifying plate 119 provides flow resistance, so that the pressure stabilizing cavity 121 is fully filled with the liquid flow, which is conductive to preventing the rapid loss of the liquid flow and preventing early separation of air and liquid. Optionally, the vortex member 117, the microhole plate 116, the flow rectifying plate 119 and the pressure maintaining member 120 may be used in any combination, which can realize the functions of refining the bubbles, and stabilizing and maintaining the pressure.

In the description of the specification, the description with reference to the terms such as “an embodiment”, “some embodiments”, “schematic embodiments”, “examples”, “specific examples”, or “some examples” refer to that the specific features, structures, materials, or characteristics described in combination with the embodiment or example are included in at least one embodiment or example of the present disclosure. In the specification, the schematic representation of the above terms does not necessarily mean the same embodiment or example. Moreover, the specific features, structures, materials or characteristics described may be combined in any one or more embodiments or examples in a suitable manner.

Although the embodiments of the present disclosure have been shown and described, those of ordinary skills in the art may understand that various changes, modifications, substitutions and variations may be made to these embodiments without departing from the principle and purpose of the present disclosure, and the scope of the present disclosure is defined by the claims and their equivalents.

What is claimed is:

1. An air suction protection structure for a microbubble device, comprising:
a first throat pipe provided with a conical opening, wherein the conical opening is arranged to allow a liquid flow to enter the first throat pipe from the conical opening, and to increase a flow speed of the liquid flow after the liquid flow passes through the conical opening;
a second throat pipe communicated with the first throat pipe and located downstream of the first throat pipe, wherein a protection area is arranged on an inner wall of the second throat pipe, and the protection area is arranged to prevent the liquid flow from contacting with an inner wall surface of the second throat pipe within the protection area; and
an air suction pipe communicated with the second throat pipe, wherein the air suction pipe is provided with an air suction port connected to the protection area.

2. The air suction protection structure for a microbubble device according to claim 1, wherein the protection area is surrounded by an extension line of an inner wall of the first throat pipe, the inner wall surface of the second throat pipe and an extension line of the conical opening.

3. The air suction protection structure for a microbubble device according to claim 1, wherein an inner diameter of the second throat pipe is greater than an inner diameter of the first throat pipe, and a cross-sectional area of the second throat pipe is not greater than twice of a cross-sectional area of the first throat pipe.

4. The air suction protection structure for a microbubble device according to claim 1, wherein an extension line of an inner wall of the conical opening intersects with the inner wall surface of the second throat pipe.

5. The air suction protection structure for a microbubble device according to claim 1, wherein an expansion port is arranged downstream of the second throat pipe, and a diameter of the expansion port is continuously increased in a downstream direction.

6. The air suction protection structure for a microbubble device according to claim 1, further comprising a structural member, wherein the structural member comprises the first throat pipe, the second throat pipe and the air suction pipe.

7. The air suction protection structure for a microbubble device according to claim 5, wherein a bubble refining device is arranged downstream of the expansion port, and the bubble refining device comprises a microhole plate.

8. The air suction protection structure for a microbubble device according to claim 7, wherein the bubble refining device comprises a vortex member, and the vortex member is configured to generate a vortex to refine bubbles when the liquid flow with the bubbles passes through the vortex member.

9. The air suction protection structure for a microbubble device according to claim 7, wherein the bubble refining device is provided with a flow rectifying plate for increasing flow resistance and controlling the flow speed of the liquid flow.

10. The air suction protection structure for a microbubble device according to claim 7, wherein the bubble refining device comprises a pressure maintaining member in which a pressure stabilizing cavity for preventing bubbles in water from overflowing is arranged.
